(19) United States
(12) Patent Application Publication
(10) Pub. No.: US 2026/0120353 A1
(43) Pub. Date: Apr. 30, 2026

(54) GENERATIVE MACHINE LEARNING MODELS FOR GENERATING ROOF DAMAGE IMAGES

(71) Applicant: State Farm Mutual Automobile Insurance Company, Bloomington, IL (US)

(72) Inventor: Jacob Braun, Oviedo, FL (US)

(21) Appl. No.: 18/932,956

(22) Filed: Oct. 31, 2024

(51) Int. Cl. G06T 11/60; G06T 5/60; G06T 5/70; G06T 7/00; G06V 20/10; G06V 20/20; G06V 20/70

(52) U.S. Cl. CPC G06T 11/60; G06T 5/60; G06T 5/70; G06T 7/001; G06V 20/176; G06V 20/20; G06V 20/70; G06T 2207/30136

(57) ABSTRACT

Techniques are described herein for generating synthetic images of damaged roofs using generative machine learning (ML) models. In various examples, a generative ML system receives text input describing roof attributes and/or damage characteristics for a synthetic image, which may be processed by a text encoder to determine a set of text embeddings. The text embeddings may be used as conditioning data for a generative ML model, such as an image diffusion model, to produce realistic synthetic images of damaged roofs. These generated images can be used to augment training datasets for additional ML models focused on roof damage detection and assessment, addressing the challenges of limited real-world training data.

### TECHNICAL FIELD

The present disclosure relates to using generative machine learning (ML) techniques for generating synthetic image data for training additional ML models focused on roof damage detection and assessment. In particular, the present disclosure relates to using generative ML models, such as image diffusion models, to generate synthetic roof damage images based on text input identifying roof surface attributes, damage attributes, and/or additional data that may be used to condition the generative model.

### BACKGROUND

Inspection and damage assessment of building roofs may be critical processes in various industries, such as insurance and construction industries. Generally, the tasks of roof inspection and damage assessment have relied heavily on manual techniques performed by human inspectors and estimators. While experienced professionals provide certain insights, these traditional approaches also may come with various challenges and limitations. For example, manual inspection and damage estimation may require considerable time and on-site resources. An estimator or inspector typically may need physical access to the roof to identify damage and determine whether replacement is necessary. This process can be time-consuming, especially when dealing with multiple properties or large-scale assessments following weather events and natural disasters. Manual roof inspections also may expose human inspectors to potentially dangerous conditions, including the risk of falling while working on elevated surfaces. This danger may be amplified in adverse weather conditions such as wind or rain, which are common in many regions. The safety concerns associated with roof inspections not only put workers at risk, but also may limit the conditions under which roof inspections or estimations can be safely conducted.

Additionally, the accuracy and consistency of manual roof inspections can be complicated or compromised by various factors and real-world challenges. Different roofing materials, roof pitch, lighting conditions, and weather conditions can make manual roof inspection and damage estimation extremely difficult, which can lead to subjective assessments that may not provide a repeatable or consistent approach. The subjective nature of human assessments may introduce variability in inspectors and damage evaluations. Two estimators examining the same roof surface may arrive at different conclusions regarding the existence or severity of the roof damage, or the necessity for repairs or replacement. Thus, traditional techniques may result in inconsistent and potentially unreliable results across different inspections or estimators. This lack of standardization can lead to disputes between property owners and insurance companies, as well as inconsistencies in claim processing and settlement.

The problems of manual roof inspection and damage estimation can be exacerbated when dealing with large-scale events, such as hurricanes, tornados, or severe storms that may large populations across a wide area. The need for rapid assessment in these situations often strains available human resources, potentially leading to delays in claims processing and property restoration. Given these challenges, there is a clear need for improved techniques that provide for efficient, accurate, and safer methods of roof inspection and damage estimation. Improvements in these industries could potentially streamline property inspections, insurance claim processing, and the initiation, execution, and evaluation of roof construction and repair projects. Such improvements also may improve the accuracy and consistency of damage evaluations and may significantly reduce the risks associated with manual roof inspections.

The example systems and methods described herein may be directed toward mitigating or overcoming one or more of the deficiencies described above.

### SUMMARY

Described herein are systems and methods for using generative machine learning (ML) models to generate synthetic images of damaged roofs. In various examples, a generative ML system may receive text input describing various roof attributes and/or damage characteristics for one or more synthetic images to be generated. The text input data, which may include natural language text, text tags, etc., may be processed by a text encoder to determine text embeddings that may be used as conditioning data for one or more generative ML models. The generative ML models, such as image diffusion models and/or generative adversarial networks (GANs) may be trained to output realistic synthetic images of damaged roof surfaces based on the conditioning inputs. In various examples, one or more generative ML models may be trained based on limited seed images and used to generate larger repositories of synthetic image data for training for additional ML models focused on roof damage detection and assessment.

As discussed above, existing techniques for roof inspection and damage estimation may face significant challenges, including time and resource constraints, safety risks, and potential inaccuracies and inconsistencies in damage assessments. These limitations can lead to delays in claims processing, inaccurate evaluations, and inefficiencies in the insurance and construction industries when dealing with roof damage assessments.

In order to address these limitations of the existing techniques, it may be desirable to use machine learning (ML) models to perform automated roof inspection and damage estimation. For example, trained computer vision models may use various ML architectures, such as convolutional neural networks (CNNs), recurrent neural networks (RNNs), graph neural networks (GNNs), and the like, to analyze roof images and output a damage assessment. Thus, a computer vision model, if sufficiently trained using robust roof image data and corresponding attribute data, may provide various technical improvements over existing techniques for roof inspection and damage estimation, including improved estimate accuracy, efficiency, consistency, and worker safety.

To generate a computer vision model that achieves high accuracy and reliability when performing roof inspection and damage estimation, the model should be trained on a large and diverse set. However, there is a general scarcity of images that depict damaged roofs, due to the infrequency of roof damage events and the logistical difficulties in capturing images of damaged roofs. Further, accurate labeling of the training images may be crucial for supervised learning approaches, to allow the computer vision model to learn the relationships between image features and corresponding damage assessment factors. However, the process of manually labeling large datasets of roof damage images may be time-consuming, error-prone, and may require expertise in damage assessment.

Even when roof damage images are available, they often lack the diversity and comprehensiveness required to train a robust ML model. To effectively train a computer vision model to analyze and assess roof damage, the training data may require a large and diverse data set of labeled images that include various combinations of roof surface types and attributes, damage types and severities, and many other image characteristics. For example, a robust set of training images may include large numbers of images of different roof surface types, materials, colors, styles, and pitches. For each of the various roof surface types and attributes, the training data should include training images depicting various examples of different possible types or causes of roof damage, such as wind damage, hail damage, fire damage, water damage, fraud damage, and the like, including various examples of different possible severities and on-roof locations for different damage types. Further, for the various roof types/attributes, and roof damage types/attributes to be supported the computer vision model, the model may be trained with sufficient numbers of training images that include various image characteristics, such as a variety of image ranges, resolutions, lighting conditions, foreign objects present, and the like.

Accordingly, various techniques are described herein (e.g., methods, computing devices and systems, non-transitory computer-readable media storing instructions, etc.) for generating large and diverse sets of synthetic images of roof damage. In various examples, techniques may include receiving text data indicating at least one of a roof surface attribute and/or a roof damage attribute, and encoding the text data into one or more text embeddings (or text encodings). The embeddings may be provided input to a generative ML model, such as an image diffusion model, trained to generate synthetic images of damaged roof surfaces corresponding to the text embeddings.

In various examples, different types and configurations of generative ML models may be used to produce the synthetic image data. In some cases, a generative ML model may include an image diffusion model configured to generate synthetic images by receiving a noise sample (e.g., random noise) and iteratively performing diffusion inference operations to de-noise the sample into a synthetic image. When de-noising the image, the diffusion model may be guided by the text embeddings, which may be used as conditioning inputs to the model and/or as diffusion guidance during the iterative de-noising operations. In other cases, other types of generative models and/or generative ML technologies may be used to generate the synthetic image data, such as generative adversarial networks (GANs), AI-based image generation tools, etc.

In some cases, a roof image generation system may be implemented including a text encoder and generative ML model. The system may be configured to receive and encode input text, and then invoke the generative ML model to generate various synthetic roof damage images. The synthetic roof damage images may be stored in a training image repository and used to train one or more additional ML model(s) (e.g., computer vision models) to analyze roof images and perform automated damage assessments. In some examples, the system may use the input text data and/or encoded text embeddings to determine image labels (or tags) that may be stored with the image repository and used for supervised training of the additional ML model(s).

As described below in more detail, the text input data received by the roof image generation system may include various combinations of roof surface descriptors and/or attributes (e.g., material type, pitch, style, color, age, etc.), as well as roof damage causes and/or attributes (e.g., damage type, location, cause, severity, etc.). In some cases, the system may be used to generate realistic synthetic images of “manufactured” roof damage, that is, human-caused damage that may be accidental or caused intentionally for fraudulent purposes. The text data also may include additional data identifying, for example, the image characteristics of the synthetic image(s) to be generated (e.g., range, resolution, lighting, etc.) and/or various additional objects to be included in the synthetic image(s) (e.g., shadows, snow or ice, or foreign objects on the roof such as leaves, pine needles, acorns, frisbees, etc.).

The techniques discussed herein can improve the functioning of computing systems and ML models in several ways. For instance, the image diffusion and other generative ML models described herein can be used to efficiently generate large and diverse datasets of synthetic roof damage images based on text input. This addresses the critical challenge of limited training data for computer vision models focused on roof damage detection and assessment. By generating high-quality synthetic images, these techniques enable more robust and accurate training of the downstream ML models without requiring extensive manual image capture, evaluation, and labeling.

Additionally, the use of text-based inputs (e.g., natural language and/or text labels) to condition the generative ML model allows for a variety of loose and/or fine-grained control strategies for generating synthetic images. For example, using specific text instructions to condition the generative ML model may enable the generation of highly specific roof damage scenarios that may be rare and/or difficult to capture using real-world image sets. For instance, the text inputs of the system can allow for targeted generation of images depicting specific combinations of roof types, damage causes, severities, environmental conditions, image characteristics, etc. In other examples, more loosely defined text inputs may be used that specify one or more image generation criteria but do not address various other criteria. As an example, the text input may specify just one (or a limited number of) image criteria, while not including any image-generation instructions directed to the various other roof type attributes, roof damage type/cause, image characteristics, etc. In these examples, the system may enforce only the specified criteria, while allowing the generative ML model to determine and render the additional unspecified image details. Thus, these techniques may provide comprehensive coverage of particular high-value scenarios (e.g., hail damage on particular roof types/pitches, fraud damage, etc.) which can significantly improve the performance of roof damage assessment models in analyzing the high-value scenarios.

Further, because the image diffusion models described herein may operate by de-noising an initial noise sample (e.g., random noise), these techniques may be used to quickly generate any number of unique synthetic images based on a single text input. Thus, diffusion models that receive and de-noise random noise samples, using conditioning data based on the text input, may provide the ability to rapidly generate large volumes of diverse, labeled training data. These techniques can accelerate the development and deployment of ML-based roof inspection systems, potentially leading to faster, safer, and more consistent damage assessments in the insurance and construction industries.

As noted above, the generative ML models described herein may be trained based on seed data (e.g., seed images). This seed data may be an exceptionally well-curated of unique roof damage images, thereby leading to distinctive training outcomes. A primary technical improvement of the techniques herein addresses a key limiting factor in existing systems for model training: the quality and quantity of data. By focusing on high-quality data, the techniques herein may significantly enhance model accuracy. In some examples, the seed image dataset may include extensive images derived from previous ground truth roof data (e.g., insurance claim image libraries) and rigorous testing conducted in research labs. Lab experiments used to generate ground truth seed images may associate particular roof damage images with variables such as hail size and roof slope under controlled conditions. Such scientifically conducted tests may produce a wealth of high-quality data, which can serve as seed data along with historical claims data. Thus, the seed data for the generative ML models may be received/generated from combination of data sources (e.g., lab experiments and previous claims) which are meticulously labeled, ensuring their reliability and utility in training the models.

The techniques described herein can be implemented in a number of ways. Example implementations are provided below with reference to the following figures. Although discussed in the context of generating synthetic roof damage images, the methods, apparatuses, and systems described herein can be applied to various different types of ML-based image generation and need not be limited to synthetic images of roof damage. For example, the techniques can be utilized to generate synthetic images for training computer vision models in other domains, such for automated inspection and damage assessments of vehicles (e.g., cars, bicycles, boats, etc.), land, building interiors and/or exteriors (e.g., floors, walls, driveways, etc.). Additionally, while specific examples of generative models are described herein (e.g., image diffusion models), these techniques can be adapted to work with other types of generative models such as generative adversarial networks (GANs), variational autoencoders, and/or transformer-based image generation models. The techniques described herein can be used with real data (e.g., seed images captured using cameras or other sensors), simulated data (e.g., generated by 3D rendering engines), or any combination of the two. Furthermore, while text inputs are discussed as conditioning data for the generative models, other forms of conditioning data could be used, such as sketches, partial images, or structured metadata.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is an illustrated flow diagram depicting an example technique for creating synthetic damaged roof images using a roof image generation system, in accordance with one or more examples described herein.

FIG. 2 is a schematic diagram illustrating an example system for generating synthetic roof damage images based on text input and using a generative machine learning (ML) model, in accordance with one or more examples described herein.

FIG. 3 is a schematic diagram illustrating an example training system for training a de-noising neural network of a diffusion ML model to generate roof damage images, in accordance with one or more examples described herein.

FIG. 4 is a schematic diagram illustrating an illustrating an example roof image generation system configured to use a text encoder and a trained diffusion ML model to generate synthetic roof damage images based on text input, in accordance with one or more examples described herein.

FIG. 5 shows an example system architecture for a computing device capable of executing program components in implementing various techniques described herein.

### DETAILED DESCRIPTION

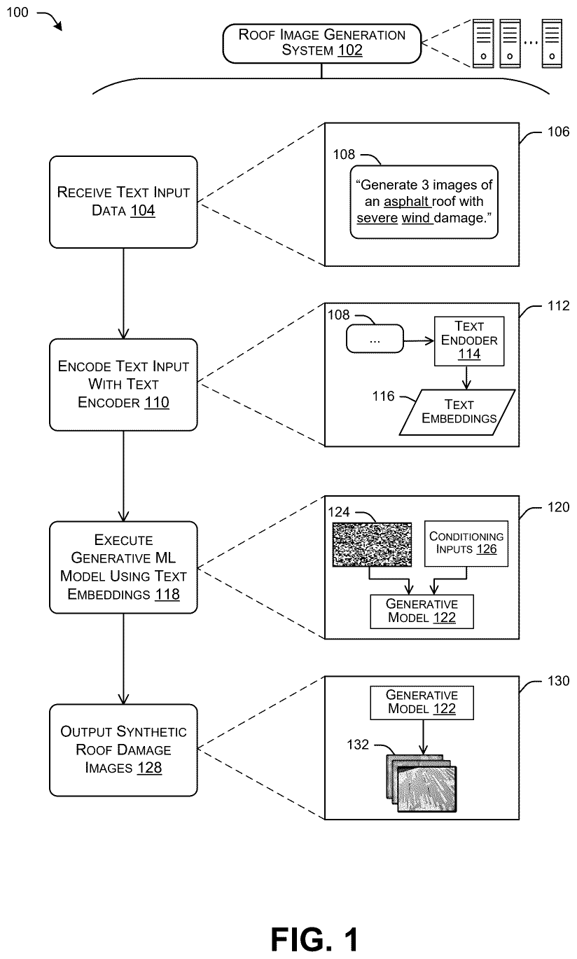

Referring to FIG. 1, a flow diagram 100 is shown depicting an example technique for creating synthetic images of damage roofs, using an image generation system 102. As shown in this example, the image generation system 102 may be designed to generate realistic synthetic images of damaged roofs (as well as undamaged roofs) that can be used as training data for training downstream ML models (e.g., computer vision models) to perform image-based inspection and damage estimation tasks. In various examples, the image generation system 102 may include one or more text encoder(s) and/or trained generative ML model(s) to generate synthetic image data based on text input describing a damaged roof.

At operation 104, the image generation system 102 may receive text input 106 indicating one or more attributes of a roof damage image (or images) to be generated by the system. In various examples, the text input 106 is received through an input interface, such as a graphical user interface window 108, a command line interface, an application programming interface (API), or any other suitable interface for receiving text input. As shown in this example, the text input 106 may be received as natural language text. In other examples, text input 106 may comprise text tags, labels, or keywords, etc.

While certain examples describe the text input 106 as being received from a user (e.g., a dataset generation engineer) via a graphical or command line interface, in other examples, the text input 106 may be received from an upstream software component. For instance, an image analysis system may analyze a real-world seed image depicting a damaged roof, identify various features or characteristics of the real-world image, and then invoke the image generation system 102 using the features and/or characteristics to generate additional synthetic images of similar roof damage scenes.

In various examples, the text input 106 may include a wide and varied range of instructions/information to control the ML-based generation of the synthetic roof damage image(s). For instance, the text input 106 may include descriptions of the roof surface itself, including roof attributes such as the roofing material type (e.g., asphalt shingles, wood shingles, tile, gables, corrugated metal, slate shingles, solar, green roof, etc.). The text input 106 also may specify a roof size, a pitch or slope (e.g., in degrees) of the roof surface, a roof style (e.g., gable, hip, flat), a color of roof surface/material, the age of the roof, a level of wear-and-tear on the roof, and the like.

Additionally or alternatively, the text input 106 may include a description (in broad or specific details) of the roof damage to be depicted in synthetic images. In some cases, the text input 106 may indicate that an undamaged roof is to be generated. When generating a damaged roof image, the text input 106 may encompass the type of damage (e.g., cracked tiles, split or missing shingles, curling, burn marks, etc.). In some cases, the text input 106 may specify a cause of the roof damage (e.g., hail, wind, fire, water, impact from falling tree, etc.). The text input 106 also may identify the severity of the damage, the degree of visible evidence of the damage, the estimated time since the damage occurred, and/or may identify specific locations on the roof where damage is or is not present.

In some cases, the text input 106 also may include descriptions of additional objects on or occluding the roof surface. Such objects may include, for example, snow or ice obscuring a portion of the roof surface, leaves or pine needles on the roof, tree branches on or covering the roof, solar panels, chimneys, pipes, vents, frisbees, and/or other objects on the roof.

Further, in some cases, the text input 106 can describe one or more features or attributes of the synthetic image itself (e.g., separate from the roof scene depicted in the image). Such image attributes may include image range (e.g., the perceived distance from which the synthetic image was captured), a source of the synthetic image (e.g., handheld camera by inspector or homeowner on roof, drone, airplane flyover, etc.), an image resolution, an image viewing angle of the roof, the portion or percentage of the roof surface visible in the image, the lighting conditions of the image, and the like.

As noted above, the text input 106 may include none, all, or any combination of these attributes, thereby allowing the image generation system 102 to be used with a high degree of customization for generating synthetic images. For instance, the text input 106 may range from an entirely generic request (e.g., an empty input or text such as “Generate a damaged roof image”), to highly specific instructions that may include details, attribute values or ranges, etc., for all of the attributes described herein (e.g., specific roof surface attributes, specific damage attributes, specific foreign object descriptions, specific image attributes, etc.). As discussed herein, this flexibility may allow users to tailor the generation of images to their specific needs, such as producing a set of similar images from a real-world seed image, or producing a robust range of generalized training data that covers a variety of different roof damage scenarios.

At operation 110, the image generation system 102 may encode the text input received in operation 104 into one or more text embeddings 116 (or text encodings) representative of the text input. As shown in box 112, the image generation system 102 may include a text encoder 114 and associated components configured to parse, extract, and encode keywords/features from the text input 106. In some examples, the text encoder 114 May include a large language model (LLM) trained on large amounts of generalized data, and/or an additional text encoder specifically trained on text relating to roofs and roof damage. An LLM or other general language text encoder may be trained to analyze the structure of the text input (e.g., natural language text), extract the key features and attributes, determine relationships between the text terms, identify negating terms, etc. Additionally or alternatively, a separate text encoder trained specifically for roof damage may be trained based on text descriptions of damaged roofs and corresponding text embeddings representing the roof, damage, and image attributes, etc.

At operation 118, the image generation system 102 may execute a generative ML model that uses the text embeddings from operation 110 to generate a synthetic image of a damaged roof representative of the text input 106. As noted above, the techniques described herein may be model agnostic, and various types of generative ML techniques may be used, including (but not limited to) diffusion models, variational autoencoders, Bayesian networks, RNNs, etc. As shown in box 120, a generative model 122 (e.g., a diffusion model) may be configured to receive a noise sample 124 (e.g., random noise) as input, and iteratively de-noise the noise sample (e.g., using a trained de-noising neural network) into a synthetic image. In this example, the generative model 122 may use conditioning inputs 126 to guide the de-noising process so that the synthetic image output by the model corresponds to the text embeddings 116.

As shown in this example, the generative model 122 may receive an input sample which is entirely noise (e.g., a random noise sample), and then de-noise the sample into a synthetic image. In other examples, the input to the generative model 122 need not be entirely noise but may be an existing roof damage image (e.g., a real-world or synthetic image) that has been partially diffused (e.g., partially injected with noise). In these cases, the generative model 122 may be used to de-noise the partially diffused image into one or more synthetic images that will more closely resemble (but are unlikely to be identical with) the existing roof damage image. Using these techniques, the generative model 122 can be used to generate synthetic images that are closely related to an existing roof damage image, but in which one or more aspects of the image may be changed (e.g., a different rood material type or style, different damage locations, different additional on or occluding objects on the roof surface, etc.). These techniques may be used to generate large numbers of relatively similar synthetic roof damage images based on a single existing image, increasing the amount of training data relating the particular roof damage scene so that any additional ML models (e.g., roof inspection models, damage assessment/estimation models, roof fraud detection models, etc.) trained on the additional training data will perform better when encountering the particular roof damage scene.

At operation 128, the image generation system 102 may output one or more synthetic images 132 based on the output of the generative model 122. In some examples, the generative model 122 may include an image decoder (or may use a separate image decoder), such as a variational autoencoder-decoder trained to decode the output of the trained de-noising neural network into a visible image. As shown in box 130, the image generation system 102 may use the generative model 122 to generate sets of related synthetic images 132 based on the same input data. For instance, using the same text input 106, the image generation system 102 may execute the generative model 122 on multiple random noise samples 124. In such cases, each of the different noise samples 124 may be de-noised differently by the generative model 122, all based on the conditioning inputs 126, to generate entirely different synthetic images that correspond to the text 106. As noted above, the sets of synthetic images produced by the generative model 122 may be stored and used as training data images for one or more separate ML models (e.g., computer vision models) focused on roof inspection, damage assessment/estimation, roof fraud detection, and the like.

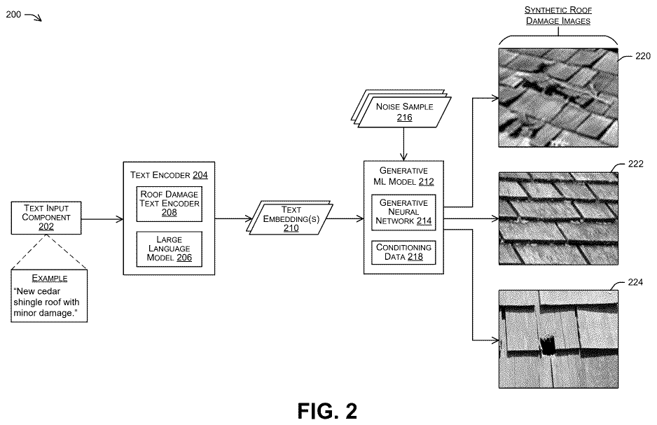

Referring to FIG. 2, an example architecture diagram of a system 200 is shown for generating synthetic images of damaged roofs based on text input. In some examples, system 200 may correspond to the image generation system 102 discussed above in FIG. 1. As shown in this example, the system 200 may include several interconnected components configured to work together to receive and process text input and use generative ML models to generate synthetic images of roof damage.

Initially, the system 200 may include a text input component 202 configured to receive text input data. In various examples, the text input component 202 may include a graphical user interface, a command line interface, an application programming interface (API), or any other suitable interface for receiving text input. In this example, the text input identifies roof attributes (e.g., roof age, roof material) and roof damage attributes (e.g., severity). In some implementations, the text input component 202 may be associated with a separate computer vision model configured to receive real-world (e.g., non-synthetized) seed images of damaged roofs. For instance, the computer vision model (or other non-ML computer vision functionality) may analyze a real-world seed image and determine a text input (e.g., text labels, natural language description, etc.) to provide to the text input component 202 based on the seed image.

As shown in this example, the text encoder 204 may use multilayer architecture including an initial large language model (LLM) 206 and a separate model comprising a roof damage text encoder 208. In some examples, the text encoder 204 may be implemented using an ML transformer or other neural network architecture. In some cases, the LLM 206 may be implemented as a set of transformer blocks and may be pre-trained using generalized language data (e.g., from various Internet data sources) so that the pre-trained LLM 206 can effectively perform general natural language processing (NLP) tasks. Unlike the LLM 206, which may be trained to perform generalized NLP tasks, the roof damage text encoder 208 may be trained to perform text encoding specific to the roof types, roof damage, image characteristics, etc. In some examples, the roof damage text encoder 208 may be implemented as one or more additional transformer layers configured to operate on top of the LLM 206.

The output from the text encoder 204 may comprise any number of text embeddings 210 (or zero text embeddings for null or blank text input data). The text embeddings may comprise encoded tokens that may be used to condition the generative ML model 212 when the model is executed to generate synthetic images. As noted above, the generative ML model 212 may be implemented using various ML techniques, model architectures, such as diffusion models, GANs, variational autoencoders, Bayesian networks, RNNs, and the like.

In this example, the generative ML model 212 includes a generative neural network 214 trained to produce synthetic images from input noise samples 216. The noise samples 216 may be received, for example, from a random noise generator component. The generative ML model 212 may use conditioning data 218, corresponding to or based on the text embeddings 210, as conditioning inputs to guide the synthetic image generation operations. As described below in more detail, the conditioning data 218 may be used as condition inputs to a trained generative model and/or during diffusion guidance operations, to guide the generation of the synthetic image from a random noise sample 216 to one or more synthetic roof damage images. In this case, the generative ML model 212 has been executed three times, using three different noise samples 216, to generate three separate synthetic roof damage images 220-224.

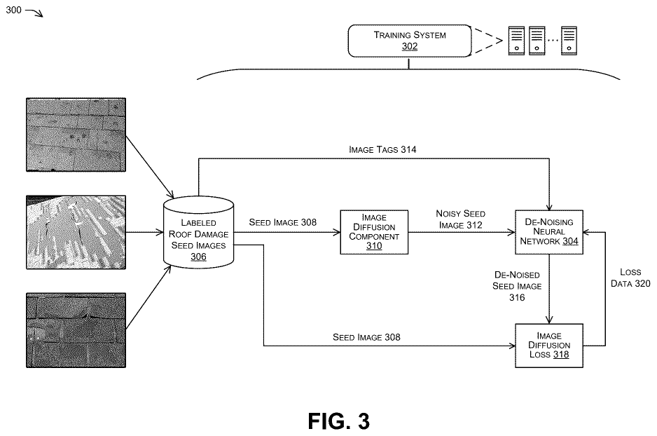

Referring to FIG. 3, a diagram 300 is shown illustrating an example training system 302 for training a de-noising neural network 304 of a generative model (e.g., an image diffusion model) for generating synthetic roof damage images. As shown in this example, training a de-noising neural network 304 may generally comprise performing a series of training operations on ground truth seed images 306 (e.g., authentic real-world images of damaged roofs). During a training operation, the training system 302 may perform a diffusion process in which noise is injected into a ground truth seed image 308 using an image diffusion component 310. After injecting the noise into the ground truth seed image 308, the training system 302 may provide the noisy seed image 312 to the de-noising neural network 304 to perform one or more de-noising operations to attempt to restore the noisy seed image 312 to the original ground truth seed image 308. In some examples, the de-noising neural network 304 may use conditioning data (e.g., based on image tags 314) to guide/condition the de-noising operations (e.g., using cross-attention layers to provide the conditioning data). The training system 302 may use an image diffusion loss component 318 to compute loss data 320 (e.g., using L1 or L2 loss functions) based on comparing the de-noised seed image 316 to the original ground truth seed image 308. Thus, the loss data 320 may be a quantifiable (e.g., numeric) value representing how effectively and accurately the de-noising neural network 304 de-noises the noisy seed image 312 back into the ground truth seed image 308 (e.g., based on differences between the original and de-noised ground truth sample), as opposed to de-noising the noisy image into a different synthetic image. The de-noising neural network 304 may be trained based on the loss data from any number of training operations performed on any number of seed images 306.

Thus, after training a de-noising neural network 304 using the techniques described herein, the de-noising neural network 304 may be used within a diffusion model to generate realistic synthetic roof damage images based on random noise samples. For example, a randomly generated noise sample may be iteratively de-noised (e.g., using the de-noising neural network 304 and conditioning data based on the image tags 314), to generate a realistic roof damage image that includes the features/attributes identified in the image tags 314.

As noted above, the roof damage seed images 306 may be authentic, real-world images captured of damaged (and undamaged) roofs. The seed images 306 may include a variety of images captured using different techniques (e.g., handheld cameras, drones, etc.) of various different roof types, damage attributes, and additional image characteristics. In some cases, the roof damage seed images 306 may be human-labeled and/or analyzed with automated feature extraction tools (e.g., a computer vision ML model) to determine a set of image tags 314 associated with each of the seed images 306.

In some examples, the image diffusion component 310 may apply a masking probability and/or percentage that determines how much of the original seed image 308 is to be obscured with random noise during the image diffusion operation. After determining a masking probability or percentage, the image diffusion component 310 may construct a noise mask to apply to the ground truth seed image 308. In some cases, injecting noise into a seed image 308 can be performed randomly on a per-pixel basis (e.g., applying a masking probability to each pixel). Additionally or alternatively, the image diffusion component 310 may determine regions or portions of the seed image 308 to obscure (e.g., replace with random noise) based on the masking percentage/probability.

The de-noising neural network 304 may be configured to perform an iterative de-noising process, ultimately outputting the de-noised seed image 316 based on an input comprising a noisy seed image 312. In some examples, the de-noising neural network 304 may use conditioning data (e.g., text embeddings or other tokens based on image tags 314) to guide the iterative de-noising process. In some examples, the diffusion model (e.g., generative ML model 212) in which de-noising neural network 304 resides (e.g., generative neural network 214) may include associated cross-attention layers used to provide the conditioning data to the de-noising neural network 304. In some examples, the de-noising neural network 304 also may receive the masking probability or percentage used by the image diffusion component 310 to inject noise into the seed image 308. Thus, the de-noising neural network 304 may learn to de-noise noisy images into synthetic roof damage images that are consistent with the image tags 314 (rather than images of unrelated damaged roofs).

The training techniques described in this example may be performed any number of times, based on the labeled (or unlabeled) seed images 306 representing any number of ground truth roof damage images. In some examples, multiple training processes may be executed based on the same seed image 308, by injecting different noise differently (e.g., different amounts and/or at different random locations), thereby robustly training the de-noising neural network 304 to effectively perform de-noising based on limited numbers of seed images.

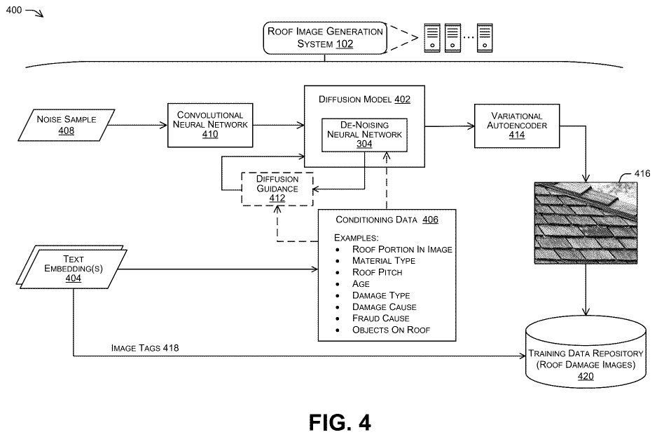

Referring to FIG. 4, a system diagram 400 is shown depicting a roof image generation system 102 configured to use a diffusion model 402 with a trained de-noising neural network 304 to generate synthetic roof damage images. As shown in this example, the roof image generation system 102 utilizes text embeddings 404 (or other text data) as input. As discussed herein, the text embeddings 404 may be generated by a text encoder 204 based on text input data. The text embeddings 404 may include encoded tokens representing the various text input provided to the system describing the desired characteristics for the synthetic images to be generated. The text embeddings 404 may represent various aspects or attributes of a roof, roof damage, and/or other characteristics of the synthetic image to be generated. As shown, the text embeddings 404 may be used as conditioning data 406 (e.g., tokens used to condition the diffusion model 402 during execution). Examples of conditioning data 406 based on text embeddings 404 may include, but are not limited to conditioning inputs (or tokens) specifying the portion of the roof to be depicted, conditioning inputs specifying the roof material type, pitch, age, or style, conditioning inputs specifying the damage type, cause, severity, or location, conditioning inputs specifying additional objects on or occluding the roof surface in the synthetic image, conditioning inputs specifying the image characteristics such as range, angle, resolution, and the like.

During execution, the diffusion model 402 may receive (or generate) a noise sample 408, which may include a random noise sample. In other examples, the diffusion model 402 need not be provided with a noise sample, but instead may be provided with an existing image of roof damage (e.g., a real-world or synthetic roof damage image) that has been partially injected with noise. The noise sample 408 (or other input image) may provided to a convolutional neural network (CNN) 410, such as U-Net trained to perform image segmentation. The output of the CNN 410 may be provided to the trained de-noising neural network 304. As described herein, the de-noising neural network 304 may be trained to iteratively de-noise input images into roof damage images, guided by the conditioning data 406.

As shown in this example, the diffusion model 402 may be configured to generate encoded image data that can be decoded by a variational autoencoder 414 into a synthetic image 416. In some cases, at each iteration, the diffusion model 402 may output a set of latent variables corresponding to a probabilistic representation of a synthetic roof damage image. In such cases, the diffusion model 402 may include a latent variable space for performing diffusion operations such as adding noise to an input image (e.g., during training by an image diffusion component 310) and/or removing noise from an input image during inference operations (e.g., by the de-noising neural network 304).

As noted above, the text embeddings 404 (e.g., based on text input describing the roof damage scenes to be generated) may be used to condition the synthetic image generation process performed using the diffusion model 402. The conditioning data 406 may influence to iterative de-noising process so that the resulting synthetic images include the desired (and valuable) attributes/features for the training data repository 420. For example, the diffusion model 402 may generate synthetic rood damage images using an iterative de-noising process in which the de-noising neural network 304 is executed repeatedly to gradually diffuse a noise sample 408 into a fully formed realistic image depicting roof damage.

After completing the iterative de-noising process, the diffusion model may provide the output (e.g., a latent space vector) to the variational autoencoder 414. In some cases, the variational autoencoder 414 may be associated with an image pixel space (e.g., rather than the latent space of the diffusion model 402), and may a decoder (e.g., a CNNs, RNN, multilayer perceptron (MLPs), etc.). The variational autoencoder 414 may be associated with and/or jointly trained with the CNN 410 in some instances. In some examples, the variational autoencoder 414 may receive embedded/encoded feature vector in latent space and may decode the feature vector into synthetic image 416.

As shown in this example, the conditioning data 406 can be used by the diffusion model 402 in various ways during the iterative de-noising process. In some implementations, the conditioning data 406, represented/encoded as tokens, can be concatenated with an embedding in the latent space of the diffusion model, and provided as input to the de-noising neural network 304. The conditioning data 406 can be provided as input to a separate de-noising algorithm that may be applied to each output of the de-noising neural network 304. For example, the de-noising algorithm may include operations to apply the conditioning data 406 over time to generate the latent space embedding output by the de-noising neural network 304 during the iterative de-noising. In such examples, each of the conditioning data 406 may be encoded into tokens using an encoder (e.g., a transformer, MLP, etc.), before being provided to the de-noising neural network 304. In these examples, when the de-noising neural network 304 is trained, the training system 302 may condition the training on conditioning inputs that correspond to the ground truth seed images. Then, during inference when a synthetic roof damage image is generated by the diffusion model 402, the conditioning data 406 can be used as input data to the diffusion model 402 as described above.

Additionally or alternatively, the diffusion model 402 may use a diffusion guidance function 412 during inference to generate synthetic roof damage images. When generating a synthetic image, the diffusion guidance function 412 may be used as an alternative or in addition to using the conditioning data 406 as input to the de-noising neural network 304. In this example, after each iterative operation in the de-noising process performed using the diffusion model 402, the output of the de-noising neural network 304 (e.g., a latent space embedding) may be decoded into an image and provided to the diffusion guidance function 412. The diffusion guidance function 412 may evaluate the output of the de-noising neural network 304 at each diffusion iteration, and may alter the output of the de-noising neural network 304 based on the evaluation. For example, the diffusion guidance function 412 may compute a loss value (e.g., using an L1 or L2 loss function) associated with a diffusion iteration, and may modify the latent space embedding output by the de-noising neural network 304 in a way that will decrease the loss score (e.g., using a gradient function).

The synthetic image 416 decoded by the variational autoencoder 414 may be stored in a training data repository 420 used to train one or more additional ML model(s) (e.g., computer vision models). Such additional ML models may include, for example, models for inspecting and analyzing roof images, perform automated damage assessments/estimations, detecting roof fraud, and the like. As shown in this example, image generation system 102 also may store the text embeddings 404 associated with a synthetic image 416 of roof damage (and/or image tags based on the text embeddings 404) in the training data repository 420, which can be used for supervised training of the additional ML model(s).

As noted above, in some examples, a roof image generation system 102 may use various alternative generative models instead of (or in addition to) the diffusion models described in the above examples. For instance, generative adversarial networks (GANs) may be used to generate synthetic roof images in some examples. Such GANs may include two neural networks: a generator network and a discriminator network, that can be trained simultaneously. The generator network may generate new data instances, while the discriminator network may evaluate the instances for authenticity. In such examples, the generator network may improve its output based on the feedback from the discriminator network, creating a dynamic feedback loop to generate highly realistic synthetic images. In other examples, the roof image generation system 102 may use one or more application programming interfaces (APIs) to invoke image generation tools such as DALL-E® and/or additional tools comprising ML models trained to generate images based on text descriptions. In such examples, the use of an API may allow the image generation system 102 to leverage the capabilities of any number of external image generation tools, potentially simplifying the system and enhancing the variety and quality of the generated images.

In some examples, the roof image generation system 102 may be specially adapted to generate images of manufactured (e.g., human-made and/or fraudulent) roof damage. For instance, the roof image generation system 102 can be invoked specifically (e.g., via the text input) to generate synthetic roof damage images in which the damage was caused accidentally or intentionally by a person, rather than by a weather event, natural disaster, etc. For instance, synthetic images of manufactured/fraudulent roof damage may depict roof damage caused by a person walking or stomping on the roof, damage caused by a person ripping off or pulling up shingles, damage caused by hammers or other tools on the roof surface in an attempt to simulate hail damage, etc. These synthetic images of manufactured/fraudulent roof damage may be especially valuable as training images for computer vision models designed to detect fraud and/or determine the likely causes of roof damage. Such systems may be particularly useful in the context of insurance, where fraudulent roof damage claims may be a significant issue. By training the image generation system 102 to generate images of damage caused by humans, the system could help in training other models to detect such fraudulent damage in real-world images. This could be achieved by requesting manufactured or fraudulent roof damage via the text input data, and/or providing text input that describes specific characteristics of potentially fraudulent damage, which can be used by the image generation system 102 to generate corresponding synthetic images.

As noted above, the synthetic images generated by the image generation system 102 also may include additional objects, such as leaves, branches, acorns, or frisbees on the surface of the damaged roof. The image generation system 102 can be specifically prompted to create roof damage images that include these objects or may include these objects organically during the de-noising operations (e.g., which may likely occur if these objects are present in the real-world seed images). These non-damage objects may be especially valuable as potential false-positive object detections that can be useful for training computer vision models to distinguish between actual roof damage and harmless objects that might be mistaken for damage. For instance, a small stick or branch on a roof surface could be mistaken for a crack in a roof tile, a frisbee might be mistaken for a hole in the roof surface, etc. By including such false positive damage objects in the generated images, the image generation system 102 can improve the training of computer vision models to recognize and correctly distinguish these false positives from actual roof damage.

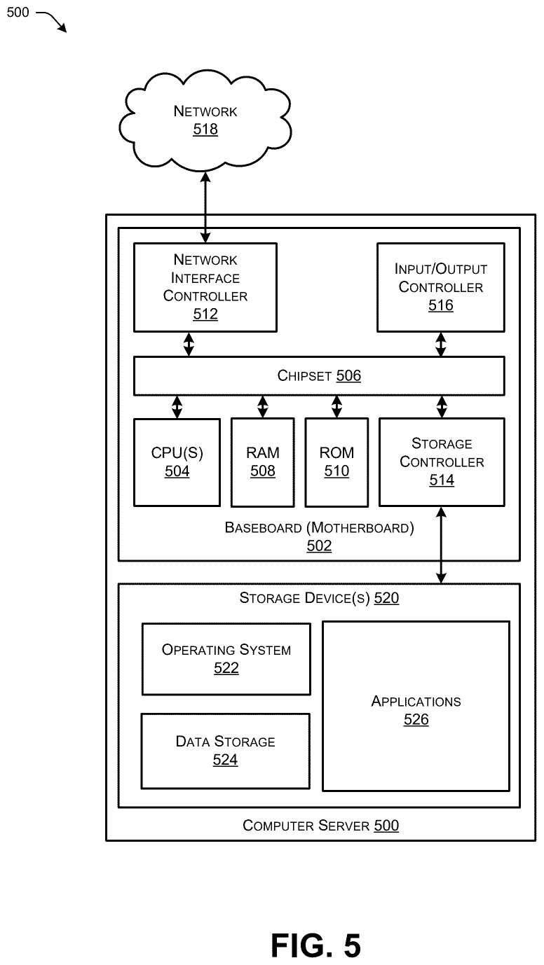

FIG. 5 shows an example computer architecture for a computer server 500 capable of executing program components for implementing the functionality described herein. The computer architecture shown in FIG. 5 may correspond to the systems and components of a server computer, workstation, desktop computer, laptop, tablet, network appliance, mobile device (e.g., tablet computer, smartphone, etc.), or other computing device, and can execute any of the software components described herein. For example, one or more computer servers 500 may correspond to and/or may be used to implement the various systems or devices described above, such as the image generation system 102, training system 302, and/or various other systems including text encoder(s) 204, generative models 212, de-noising neural networks 304, training data repositories 420, and/or any other components described herein. It will be appreciated that in various examples described herein, a computer server 500 might not include all of the components shown in FIG. 5, can include additional components that are not explicitly shown in FIG. 5, and/or may utilize a different architecture from that shown in FIG. 5.

The computer server 500 includes a baseboard 502, or “motherboard,” which may be a printed circuit board to which a multitude of components or devices are connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computer server 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer server 500. The chipset 506 can further provide an interface to a computer-readable storage medium such as a ROM 510 or non-volatile RAM (“NVRAM”) for storing basic routines that help to startup the computer server 500 and to transfer information between the various components and devices. The ROM 510 or NVRAM can also store other software components necessary for the operation of the computer server 500 in accordance with the configurations described herein.

The computer server 500 can operate in a networked environment using logical connections to remote computing devices and computer systems through a network, such as the network 518, which may be similar or identical to the various communication links and/or network(s) discussed above. The chipset 506 also may include functionality for providing network connectivity through a Network Interface Controller (NIC) 512, such as a gigabit Ethernet adapter. The NIC 512 is capable of connecting the computer server 500 to other computing devices over the network 518. It should be appreciated that multiple NICs 512 can be present in the computer server 500, connecting the computer to other types of networks and remote computer systems. In some instances, the NICs 512 may include at least on ingress port and/or at least one egress port.

The computer server 500 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device.

The computer server 500 can include one or more storage device(s) 520, which may be connected to and/or integrated within the computer server 500, that provide non-volatile storage for the computer server 500. The storage device(s) 520 can store an operating system 522, data storage systems 524, and/or applications 526, which are described in more detail herein. The storage device(s) 520 can be connected to the computer server 500 through a storage controller 514 connected to the chipset 506. The storage device(s) 520 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer server 500 can store data on the storage device(s) 520 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device(s) 520 are characterized as primary or secondary storage, and the like.

For example, the computer server 500 can store information to the storage device(s) 520 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer server 500 can further read information from the storage device(s) 520 by detecting the physical states or characteristics of one or more particular locations within the physical storage units.

In addition to the storage device(s) 520 described above, the computer server 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer server 500. In some examples, the various operations performed by a computing system (e.g., image generation system 102, training system 302, etc.) may be supported by one or more devices similar to computer server 500. Stated otherwise, some or all of the operations described herein may be performed by one or more computers server 500 operating in a networked (e.g., client-server or cloud-based) arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device(s) 520 can store an operating system 522 utilized to control the operation of the computer server 500. In some examples, the operating system 522 comprises a LINUX operating system. In other examples, the operating system 522 comprises a WINDOWS® SERVER operating system from MICROSOFT Corporation of Redmond, Washington. In further examples, the operating system 522 can comprise a UNIX operating system or one of its variants. It should be appreciated that other operating systems can also be utilized. The storage device(s) 520 can store other system or application programs and data utilized by the computer server 500.

In various examples, the storage device(s) 520 or other computer-readable storage media is encoded with computer-executable instructions which, when loaded into the computer server 500, transform the computer from a general-purpose computing system into a special-purpose computer capable of implementing various techniques described herein. These computer-executable instructions transform the computer server 500 by specifying how the CPUs 504 transition between states, as described above. In some examples, the computer server 500 may have access to computer-readable storage media storing computer-executable instructions which, when executed by the computer server 500, perform the various techniques described herein. The computer server 500 can also include computer-readable storage media having instructions stored thereupon for performing any of the other computer-implemented operations described herein.

As illustrated in FIG. 5, the storage device(s) 520 may store one or more data storage systems 524 configured to store data structures and other data objects. Additionally, the software applications 526 stored on the computer server 500 may include one or more client applications, services, and/or other software components. For example, application(s) 526 may include any combination of the components 302-308 in an image generation system 102, training system 302, and/or any combination of the software components described above in reference to FIGS. 1-4.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.”

As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method for generating synthetic roof images, the method comprising:
receiving text data indicating at least one of a roof surface attribute or a roof damage attribute;
providing the text data as input to a generative model, wherein the generative model is a machine learning (ML) model trained to generate images of damaged roof surfaces; and
generating, based on an output of the generative model, a synthetic image of a damaged roof.

2. The method of claim 1, wherein the generative model is a diffusion model configured to generate the synthetic image by iteratively performing diffusion inference operations.

3. The method of claim 2, wherein the diffusion model is configured to use the text data as at least one of:
a conditioning input to the diffusion model; or
a diffusion guidance input during the diffusion inference operations.

4. The method of claim 2, further comprising:
performing a first execution of the diffusion model based on a first random noise sample and a conditioning input based on the text data;
receiving the synthetic image based on the first execution of the diffusion model; and
performing a second execution of the diffusion model based on a second random noise sample and the conditioning input; and
receiving a second synthetic image, different from the synthetic image, based on the second execution of the diffusion model.

5. The method of claim 1, further comprising:
determining one or more image tags based on the text data; and
training a second machine learning model using training data including the synthetic image and the image tags, wherein the second machine learning model is trained to detect roof damage based on input image data.

6. The method of claim 5, wherein:
the synthetic image comprises a representation of manufactured roof damage; and
the image tags include a tag indicating that the damaged roof in the synthetic image is manufactured damage.

7. The method of claim 1, wherein the text data indicates a roof surface attribute comprising at least one of:
a roof material type;
a roof pitch; or
a roof age, and
wherein the text data indicates a roof damage attribute comprising at least one of:
a damage location;
a damage cause; or
a damage severity.

8. The method of claim 1, further comprising:
receiving additional data identifying an object to be included in the synthetic image of the damaged roof; and
providing the additional data as a conditioning input to the generative model.

9. A computer server for generating model training data, the computer server comprising:
one or more processors; and
memory storing computer-executable instructions that, when executed by the one or more processors, cause the computer server to perform operations comprising:
receiving, by the computer server, input data describing at least one attribute of a roof surface;
providing, by the computer server, the at least one attribute as input to an image diffusion generative model trained to generate images of damaged roof surfaces;
receiving, by the computer server, an output of the image diffusion generative model; and
generating, by the computer server and based on the output, a first synthetic image of a damaged roof.

10. The computer server of claim 9, wherein the image diffusion generative model is configured to use the at least one attribute as at least one of:
one or more conditioning inputs to the image diffusion generative model; or
one or more diffusion guidance inputs during an iterative diffusion inference operation performed by the image diffusion generative model.

11. The computer server of claim 9, the operations further comprising:
performing a first execution of the image diffusion generative model based on a first random noise sample and a conditioning input based on the at least one attribute;
receiving the first synthetic image based on the first execution of the image diffusion generative model; and
performing a second execution of the image diffusion generative model based on a second random noise sample and the conditioning input; and
receiving a second synthetic image, different from the first synthetic image, based on the second execution of the image diffusion generative model.

12. The computer server of claim 9, the operations further comprising:
determining one or more image tags based on the input data; and
training a second machine learning model using training data including the first synthetic image and the image tags, wherein the second machine learning model is trained to detect roof damage based on input image data.

13. The computer server of claim 12, wherein:
the first synthetic image comprises a representation of manufactured roof damage; and
the image tags include a tag indicating that the damaged roof in the first synthetic image is manufactured damage.

14. The computer server of claim 9, wherein the at least one attribute includes a roof surface attribute representing at least one of:
a roof material type;
a roof pitch; or
a roof age, and
wherein the at least one attribute includes a roof damage attribute representing at least one of:
a damage location;
a damage cause; or
a damage severity.

15. The computer server of claim 9, the operations further comprising:
receiving additional data identifying an object to be included in the first synthetic image of the damaged roof; and
providing the additional data as a conditioning input to the image diffusion generative model.

16. One or more non-transitory computer-readable media storing instructions executable by a processor, wherein the instructions, when executed by the processor, cause the processor to perform operations comprising:
receiving text input data describing at least one attribute of a roof surface;
providing the at least one attribute as input to a diffusion model trained to generate images of damaged roof surfaces;
receiving an output of the diffusion model; and
generating, based on the output, a first synthetic image of a damaged roof.

17. The one or more non-transitory computer-readable media of claim 16, wherein the diffusion model is configured to use the at least one attribute as at least one of:
one or more conditioning inputs to the diffusion model; or
one or more diffusion guidance inputs during an iterative diffusion inference operation performed by the diffusion model.

18. The one or more non-transitory computer-readable media of claim 16, the operations further comprising:
performing a first execution of the diffusion model based on a first random noise sample and a conditioning input based on the at least one attribute;
receiving the first synthetic image based on the first execution of the diffusion model; and
performing a second execution of the diffusion model based on a second random noise sample and the conditioning input; and
receiving a second synthetic image, different from the first synthetic image, based on the second execution of the diffusion model.

19. The one or more non-transitory computer-readable media of claim 16, the operations further comprising:
determining one or more image tags based on the text input data; and
training a second machine learning model using training data including the first synthetic image and the image tags, wherein the second machine learning model is trained to detect roof damage based on input image data.

20. The one or more non-transitory computer-readable media of claim 19, wherein:
the first synthetic image comprises a representation of manufactured roof damage; and
the image tags include a tag indicating that the damaged roof in the first synthetic image is manufactured damage.
